(19) United States
(12) Patent Application Publication
(10) Pub. No.: US 2006/0087766 A1
(43) Pub. Date: Apr. 27, 2006

(54) Thin film magnetic head with small track width

(75) Inventors: Kazue Kudo, Kanagawa (JP); Youji Maruyama, Saitama (JP); Tetsuya Okai, Kanagawa (JP); Hiromi Shiina, Ibaraki (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/258,458

(22) Filed: Oct. 24, 2005

(30) Foreign Application Priority Data
Oct. 25, 2004 (JP) 2004-309142

(51) Int. Cl. G11B 5/147

(52) U.S. Cl. 360/126

(57) ABSTRACT

In one embodiment, above a read head, a separating layer comprising a nonmagnetic insulating layer is formed. On the separating layer, a lower magnetic yoke is formed. On the lower magnetic yoke, a pedestal magnetic pole is formed at the front end (air bearing surface side). On the pedestal magnetic pole, a lower magnetic pole, a write gap and an upper magnetic pole are formed. The lower magnetic pole widens as the distance from the write gap increases. On the lower magnetic yoke, a conductor coil is formed via an insulating layer. On the upper magnetic pole, an upper magnetic yoke is formed to constitute a write head. The front end of the upper magnetic yoke is recessed from the front end of the upper magnetic pole. The front end portion of the upper magnetic yoke is magnetically connected with the upper magnetic pole whereas the rear end portion is magnetically connected with the lower magnetic yoke.

### CROSS-REFERENCES TO RELATED APPLICATIONS

This application claims priority from Japanese Patent Application No. JP2004-309142, filed Oct. 25, 2004, the entire disclosure of which is incorporated herein by reference.

### BACKGROUND OF THE INVENTION

The present invention relates to a thin film magnetic head for use in a magnetic disk drive. In particular, the invention relates to a thin film magnetic head having a small track width suitable for high-density recording.

To raise the recording density of a magnetic disk drive, it is necessary to narrow the recording track width of the thin film magnetic head. The recording track width of a thin film magnetic head is determined by shaping of a magnetic film structure. After the magnetic films are laminated, resist is coated on the magnetic film structure. A resist pattern is formed through exposure and development by a photolithography system. The magnetic film structure is shaped by using the resist pattern as a mask. Therefore, a high resolution photolithography system is required to narrow the track width. In the shaping process which determines the track width, the ion milling method is used since magnetic films do not allow selective etching.

Meanwhile, narrowing the track width makes it difficult to obtain a high magnetic field since the volumes of the magnetic films are reduced. To solve this problem, the magnetic films constituting the track section are made thicker. In this conventional approach, however, the track width cannot be obtained with high accuracy since thick magnetic films are difficult to shape by ion milling. As a solution to this problem, Patent Document 1 (Japanese Patent Laid-Open No. 2003-85709) discloses a method in which a resist frame is formed to continuously laminate a lower magnetic pole projection layer, a write gap and an upper magnetic pole front end layer by plating.

### BRIEF SUMMARY OF THE INVENTION

Narrowing the recording track width to raise the recording density poses a problem that a high magnetic field cannot be generated since the magnetic leakage field increases in the recording track section.

It is a feature of the present invention to provide a narrow track width thin film magnetic head free from a large magnetic leakage field.

A thin film magnetic head including a read head and a write head according to an aspect of the present invention is characterized in that the read head is provided on a slider member having an air bearing surface, and the write head comprises a lower magnetic yoke adjacent to the read head; a pedestal magnetic pole provided on the air bearing surface side of the lower magnetic yoke; a laminated structure having a lower magnetic pole provided on the pedestal magnetic pole, a write gap provided thereon and an upper magnetic pole provided thereon, wherein the lower magnetic pole widens as the distance from the write gap increases; an upper magnetic yoke wherein the front end portion is recessed from the air bearing surface side of the laminated structure's upper magnetic pole and magnetically connected with the laminated structure's upper magnetic pole and the rear end portion is magnetically connected with the lower magnetic yoke; and a conductor coil provided between the lower magnetic yoke and the upper magnetic yoke.

In some embodiments, the lower magnetic pole widens toward the pedestal magnetic pole. Preferably, the widening angle of the lower magnetic pole is 30 to 45 degrees with respect to the upper surface of the pedestal magnetic pole. In terms of section area along the depth direction, the lower magnetic pole, the upper magnetic pole and the upper magnetic yoke may be designed such that the upper magnetic yoke is larger than the upper magnetic pole and the upper magnetic pole is larger than the lower magnetic pole. Preferably, the pedestal magnetic pole is recessed from the air bearing surface. Preferably, the lower magnetic yoke and the pedestal magnetic pole are recessed from the air bearing surface.

A thin film magnetic head including a read head and a write head according to another aspect of the present invention is characterized in that the read head includes: a lower magnetic shield layer provided on a slider member having an air bearing surface; a read gap provided on the lower magnetic shield layer; a read element provided in the read gap; and an upper magnetic shield layer provided on the read gap. The write head includes: a lower magnetic yoke adjacent to the read head; a pedestal magnetic pole provided on the air bearing surface side of the lower magnetic yoke; a laminated structure having a lower magnetic pole provided on the pedestal magnetic pole, a write gap provided thereon and an upper magnetic pole provided thereon, wherein the lower magnetic pole widens as the distance from the write gap increases; an upper magnetic yoke wherein the front end portion is recessed from the air bearing surface side of the laminated structure's upper magnetic pole and magnetically connected with the laminated structure's upper magnetic pole and the rear end portion is magnetically connected with the lower magnetic yoke; and a conductor coil provided between the lower magnetic yoke and the upper magnetic yoke.

In some embodiments, the lower magnetic pole widens toward the pedestal magnetic pole. Preferably, the widening angle of the lower magnetic pole is 30 to 45 degrees with respect to the upper surface of the pedestal magnetic pole. In terms of section area along the depth direction, the lower magnetic pole, the upper magnetic pole and the upper magnetic yoke are designed such that the upper magnetic yoke is larger than the upper magnetic pole and the upper magnetic pole is larger than the lower magnetic pole. Preferably, the pedestal magnetic pole is recessed from the air bearing surface. Preferably, the lower magnetic yoke and the pedestal magnetic pole are recessed from the air bearing surface.

According to the present invention, it is possible to provide a narrow track width thin film magnetic head free from a large magnetic leakage field.

### BRIEF DESCRIPTION OF THE DRAWINGS

FIG. 1 is a perspective diagram showing the configuration of a thin film magnetic head according to an embodiment of the present invention viewed from the air bearing side.

FIG. 2 is a sectional view of the thin film magnetic head of FIG. 1.

FIG. 3 shows how the magnetic poles of the write head are fabricated.

FIG. 4 shows how the magnetic poles of the write head are fabricated.

FIG. 5 is a front view of an alteration of the thin film magnetic head according to another embodiment of the present invention.

FIG. 6 is a perspective diagram of the thin film magnetic head of FIG. 5.

FIG. 7 is a perspective diagram of an alteration of the thin film magnetic head according to another embodiment of the present invention.

FIG. 8 is a plan diagram showing the basic configuration of the magnetic disk drive.

### DETAILED DESCRIPTION OF THE INVENTION

FIG. 8 shows the basic configuration of the magnetic disk drive. A magnetic disk 2, mounted to the rotation axis 3 of a spindle motor, is rotated when information is input/output. A thin film head 1 is held by a suspension 4 which is attached to one end of an arm 5. The other end of the arm 5 is held by a rotary actuator 6. The suspension 4 functions to keep the thin film magnetic head 1 above the magnetic disk by a certain force. Processing of the read signal and inputting/outputting of information are performed in an electric circuit 7. The thin film magnetic head 1 moves above the magnetic disk 2 when the rotary actuator 6 is rotated. After being located to a certain position, the thin film magnetic head 1 writes or reads magnetic information.

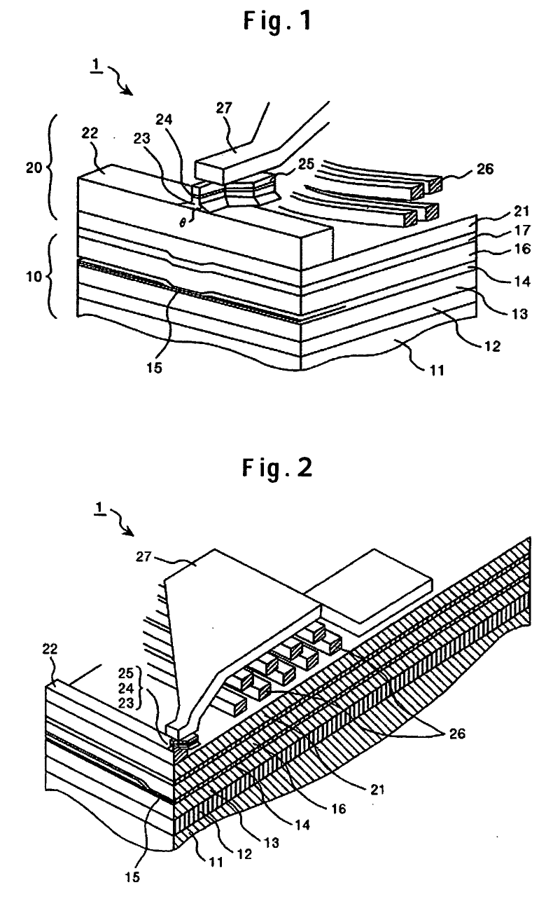

Referring to FIG. 1 and FIG. 2, the following describes the configuration of the thin film magnetic head 1, according to an embodiment of the present invention. FIG. 1 is a perspective view of a front end portion of the thin film magnetic head 1 while FIG. 2 is a sectional view of the thin film magnetic head 1. On a slider member 11, a lower magnetic shield layer 13 is formed via a nonmagnetic insulating layer 12. On the lower magnetic shield layer 13, a read gap 14 comprising a nonmagnetic insulating layer is formed. In the read gap 14, a read element 15 comprising a MR (magnetoresistive) element or a GMR (giant magnetoresistive) is placed. On the read gap 14, an upper magnetic shield layer 16 is formed to constitute a read head 10.

On the upper magnetic shield layer 16, a separating layer 17 comprising a nonmagnetic insulating layer is formed. On the separating layer 17, a lower magnetic yoke 21 is formed. On the lower magnetic yoke 21, a pedestal magnetic pole 22 is formed at the front end (air bearing surface side). On the pedestal magnetic pole 22, a laminated structure is formed which comprises a lower magnetic pole 23, a write gap 24 and an upper magnetic pole 25. The lower magnetic pole 23 widens as the distance from the write gap 24 increases. On the lower magnetic yoke 21, a conductor coil 26 is formed via an insulating layer. On the upper magnetic pole 25, an upper magnetic yoke 27 is formed to constitute a write head 20. The front end of the upper magnetic yoke 27 is recessed from the front end of the upper magnetic pole 25. The front end portion of the upper magnetic yoke 27 is magnetically connected with the upper magnetic pole 25 whereas the rear end portion is magnetically connected with the lower magnetic yoke 21. The conductor coil 26 is sandwiched between the upper magnetic yoke 27 and the lower magnetic yoke 21. Although not shown in the figure, a hard insulating protective layer is formed on the write head 20.

In the above-mentioned configuration, since the lower magnetic pole 23 of the write head 20 widens as the distance from the write gap 24 increases, the quantity of the magnetic flux passing through the lower magnetic pole 23 is increased. Thus, it is possible to generate a higher magnetic field since the magnetic leakage field is reduced. Preferably, the widening angle θ of the lower magnetic pole 23 is in the range of about 30 to 45 degrees toward the surface of the pedestal magnetic pole 22.

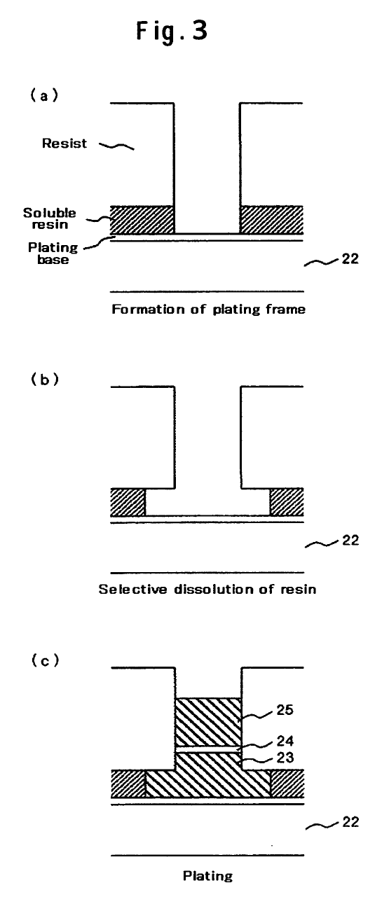

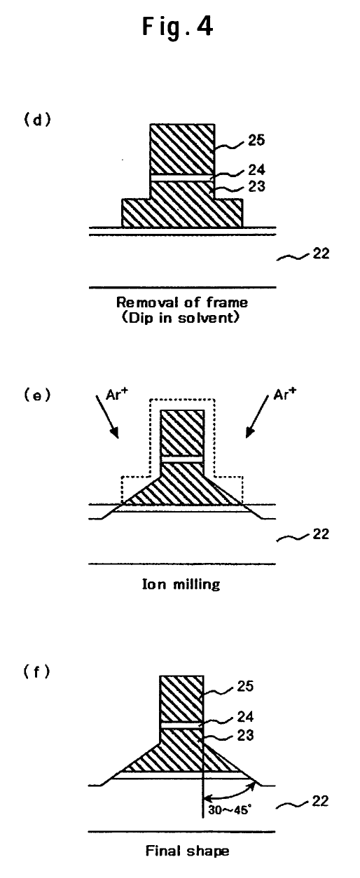

Referring now to FIG. 3 and FIG. 4, the following describes how the laminated structure comprising the lower magnetic pole 23, write gap 24 and upper magnetic pole 25 of the write head 20 is fabricated. As shown in FIG. 3(a), a plating base is formed on the pedestal magnetic pole 22 and soluble resin is coated on the plating base. Then, resist is coated on the soluble resin so as to form a plating frame having a groove wider than the recording track width. Then, as shown in FIG. 3(b), the first layer of soluble resin layer is selectively dissolved with solvent. Then, as shown in FIG. 3(c), the lower magnetic pole 23, the write gap 24 and the upper magnetic pole 25 are continuously plated by using the plating frame as a mask. Then, as shown in FIG. 4(d), the plating frame is removed by dipping the laminated structure in solvent. Then, as shown in FIG. 4(e), by performing milling by Ar ions, the laminated structure is slimmed to the recording track width, the bottom projecting portion of the lower magnetic pole 23 is tapered and the plating base is removed. FIG. 4(f) shows the shape of the laminated structure after the ion milling. The lower magnetic pole 23 is widened as the distance from the write gap 24 increases. The widening angle is between about 30 and 45 degrees.

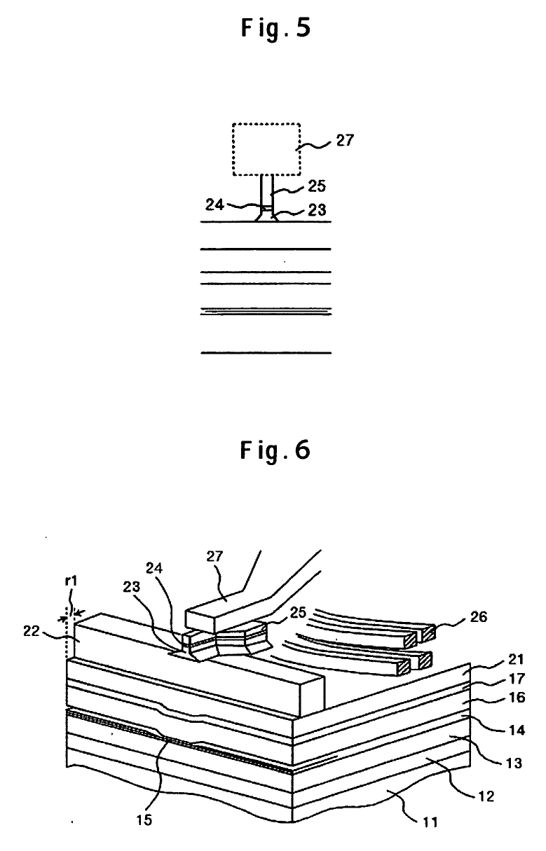

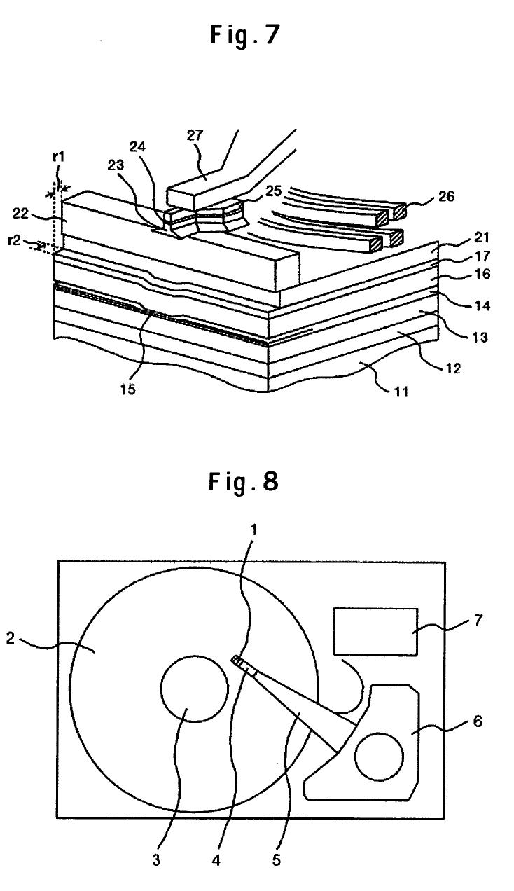

The following describes alterations of the above-mentioned embodiment. In the case of an example shown in FIG. 5, the upper plated magnetic layer is formed so as to have a larger section area along the depth direction. As compared with the above-mentioned embodiment, the upper magnetic pole 25 as well as the upper magnetic yoke 27 is formed thicker. This configuration reduces the magnetic leakage field from the upper magnetic pole 25 and the upper magnetic yoke 27. In the case of an example shown in FIG. 6, the pedestal magnetic pole 22 is recessed by r1 from the air bearing surface. As compared with the above-mentioned embodiment, the magnetic leakage field from the pedestal magnetic pole 22 is reduced in this configuration. In the case of an example shown in FIG. 7, the pedestal magnetic pole 22 is recessed by r1 from the air bearing surface and the lower magnetic yoke 21 is recessed by r2 from the air bearing surface. In the specific embodiment shown, r2>r1. As compared with the above-mentioned embodiment, the magnetic leakage field from the pedestal magnetic pole 22 and the lower magnetic yoke 21 is reduced in this configuration.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. A thin film magnetic head comprising a read head and a write head wherein,
the read head is provided on a slider member having an air bearing surface, and
the write head comprises a lower magnetic yoke adjacent to the read head; a pedestal magnetic pole provided on the air bearing surface side of the lower magnetic yoke; a laminated structure having a lower magnetic pole provided on the pedestal magnetic pole, a write gap provided thereon and an upper magnetic pole provided thereon, wherein the lower magnetic pole widens as a distance from the write gap increases; an upper magnetic yoke having a front end portion recessed from the air bearing surface side of the laminated structure's upper magnetic pole and magnetically connected with the laminated structure's upper magnetic pole and the rear end portion is magnetically connected with the lower magnetic yoke; and a conductor coil provided between the lower magnetic yoke and the upper magnetic yoke.

2. The thin film magnetic head according to claim 1, wherein the lower magnetic pole widens toward the pedestal magnetic pole.

3. The thin film magnetic head according to claim 1, wherein the widening angle of the lower magnetic pole is about 30 to 45 degrees with respect to an upper surface of the pedestal magnetic pole.

4. The thin film magnetic head according to claim 1, wherein the pedestal magnetic pole is recessed from the air bearing surface.

5. The thin film magnetic head according to claim 1, wherein the lower magnetic yoke and the pedestal magnetic pole are recessed from the air bearing surface.

6. The thin film magnetic head according to claim 5, wherein the lower magnetic yoke is recessed from the air bearing surface by an amount greater than an amount by which the pedestal magnetic pole is recessed from the air bearing surface.

7. The thin film magnetic head according to claim 1, wherein a distance from the air bearing surface to an opposite end of the pedestal magnetic pole opposite to the air bearing surface is shorter than a distance from the air bearing surface to an opposite end of the lower magnetic pole opposite to the air bearing surface.

8. A thin film magnetic head comprising a read head and a write head wherein,
the read head comprises a lower magnetic shield layer provided on a slider member having an air bearing surface; a read gap provided on the lower magnetic shield layer; a read element provided in the read gap; and an upper magnetic shield layer provided on the read gap, and
the write head comprises a lower magnetic yoke adjacent to the read head; a pedestal magnetic pole provided on the air bearing surface side of the lower magnetic yoke; a laminated structure having a lower magnetic pole provided on the pedestal magnetic pole, a write gap provided thereon and an upper magnetic pole provided thereon, wherein the lower magnetic pole widens as a distance from the write gap increases; an upper magnetic yoke having a front end portion recessed from the air bearing surface side of the laminated structure's upper magnetic pole and magnetically connected with the laminated structure's upper magnetic pole and the rear end portion is magnetically connected with the lower magnetic yoke; and a conductor coil provided between the lower magnetic yoke and the upper magnetic yoke.

9. The thin film magnetic head according to claim 8, wherein the lower magnetic pole widens toward the pedestal magnetic pole.

10. The thin film magnetic head according to claim 8, wherein the widening angle of the lower magnetic pole is about 30 to 45 degrees with respect to an upper surface of the pedestal magnetic pole.

11. The thin film magnetic head according to claim 8, wherein the pedestal magnetic pole is recessed from the air bearing surface.

12. The thin film magnetic head according to claim 8, wherein the lower magnetic yoke and the pedestal magnetic pole are recessed from the air bearing surface.

13. The thin film magnetic head according to claim 12, wherein the lower magnetic yoke is recessed from the air bearing surface by an amount greater than an amount by which the pedestal magnetic pole is recessed from the air bearing surface.

14. The thin film magnetic head according to claim 8, wherein a distance from the air bearing surface to an opposite end of the pedestal magnetic pole opposite to the air bearing surface is shorter than a distance from the air bearing surface to an opposite end of the lower magnetic pole opposite to the air bearing surface.
